(19) United States
(12) Patent Application Publication
(10) Pub. No.: US 2008/0140406 A1
(43) Pub. Date: Jun. 12, 2008

(54) Data-Processing Device and Method for Informing a User About a Category of a Media Content Item

(75) Inventors: Dzevdet Burazerovic, Eindhoven (NL); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,040

(22) PCT Filed: Oct. 10, 2005
(86) PCT No.: PCT/IB2005/053315

§ 371 Date: Apr. 11, 2007

(30) Foreign Application Priority Data
Oct. 18, 2004 (EP) 04105110.3

(51) Int. Cl. G10L 13/04

(52) U.S. Cl. 704/260; 704/270; 725/39; 704/E19.001; 704/E13.001

(57) ABSTRACT

The invention relates to a method of informing a user about a category (152) of a media content item. The method comprises the steps of: identifying the category of the media content item, and enabling a user to obtain an audible signal (156) having an audio parameter (153) in accordance with the category of the media content item. The invention further relates to a device, which is capable of functioning in accordance with the method. The invention also relates to audio data comprising an audible signal informing a user about a category of a media content item, a database comprising a plurality of the audio data, and a computer program product. In a recommender system, the audible signal may be reproduced by the recommender system when a user interaction with the recommender system relates to the media content item of a particular genre. The invention may be used in the EPG user interface.

The invention relates to a method of informing a user about a category of a media content item, and to a device which is capable of functioning in accordance with the method. The invention also relates to audio data comprising an audible signal informing a user about a category of a media content item, a database comprising a plurality of the audio data, and a computer program product.

WO0184539A1 discloses a consumer electronics system for supplying an auditory feedback to a user in response to a user command input. The system pronounces, in a pre-recorded or synthetic voice, the name of the artist and the title of the song or album of the media content selected for playback. The synthetic voice uses a text-to-speech engine to convert words from a computer document into audible speech through a loudspeaker.

The known system has the drawback that the audible speech is not satisfactorily reproduced to the user. The auditory feedback is presented to the user in an unattractive manner.

One of the objects of the present invention is to improve the system so that auditory information is presented to the user in an attractive manner.

The method of the present invention comprises the steps of:
identifying the category of the media content item, and
enabling a user to obtain an audible signal having an audio parameter in accordance with the category of the media content item.

For example, a particular TV program belongs to a movie genre. The genre of the TV program is determined from EPG (Electronic Program Guide) data. Together with the TV program, the EPG data is provided to a TV set. The title of the TV program, i.e. the movie, is audibly presented to the user. The TV set produces the audible signal which has at least one audio parameter, e.g. a temporal characteristic or pitch (e.g. of a famous actor's voice), which the user associates with the movie category. The user may not even have watched the movie with such a title, but the manner in which the title is reproduced suggests to the user that it is probably a movie of a specific genre.

The system known from WO0184539A1 produces audible speech which sounds similarly to the user for different information items. Thus, whenever the known system informs the user about some TV program, it sounds the same.

It is an advantage of the present invention that the audible signal presented to the user enables him to find out the category of the media content item when the category is not even explicitly pronounced with the audible signal. The user may understand the category of the media content item when e.g. only a title of the item is presented. For example, the audible signal may not comprise any word like “movie” or “news” because the category is apparent to the user without such explicit information about the category. Hence, the present invention allows informing the user about the category more efficiently than in the prior art.

The present invention may be used in a recommender system for recommending the media content item to the user, or in a media content browser system for enabling the user to browse media content.

In an embodiment of the present invention, the media content item is associated with two or more categories. For example, a movie is associated with an action genre and a comedy genre, but there are more action scenes in the movie than comedy scenes. Thus, the action genre is dominant for the movie. The movie is recommended to the user with the audible signal having the audio parameter which is associated with the action genre.

An object of the present invention is realized in that the data-processing device for informing a user about a category of a media content item comprises a data processor configured to
identify the category of the media content item, and
enable the user to obtain an audible signal having an audio parameter in accordance with the category of the media content item.

The device is designed to function in accordance with the steps of the method of the present invention.

According to the invention, audio data comprises an audible signal informing a user about a category of a media content item when said audible signal is presented to the user, the audible signal having an audio parameter in accordance with the category of the media content item.

These and other aspects of the invention will be further explained and described, by way of example, with reference to the following drawings:

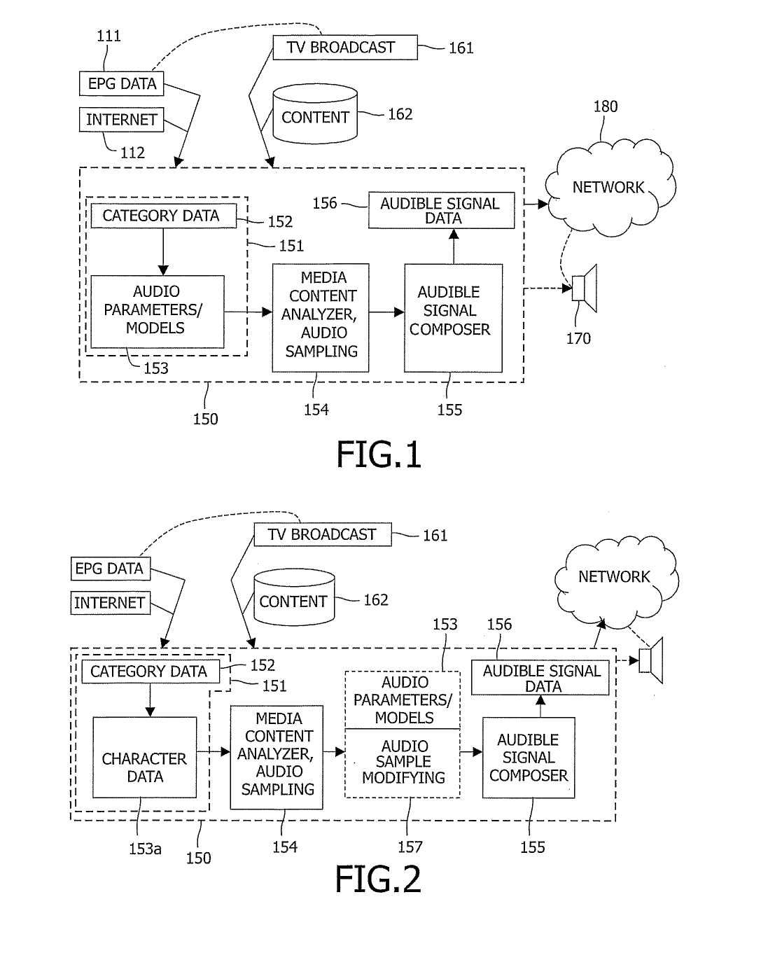

FIG. 1 is a functional block diagram of an embodiment of a device according to the present invention, wherein at least one audio sample having the audio parameter associated with the category is obtained;

FIG. 2 is a functional block diagram of an embodiment of a device according to the present invention, wherein at least one audio sample articulated by a particular character associated with the category is obtained;

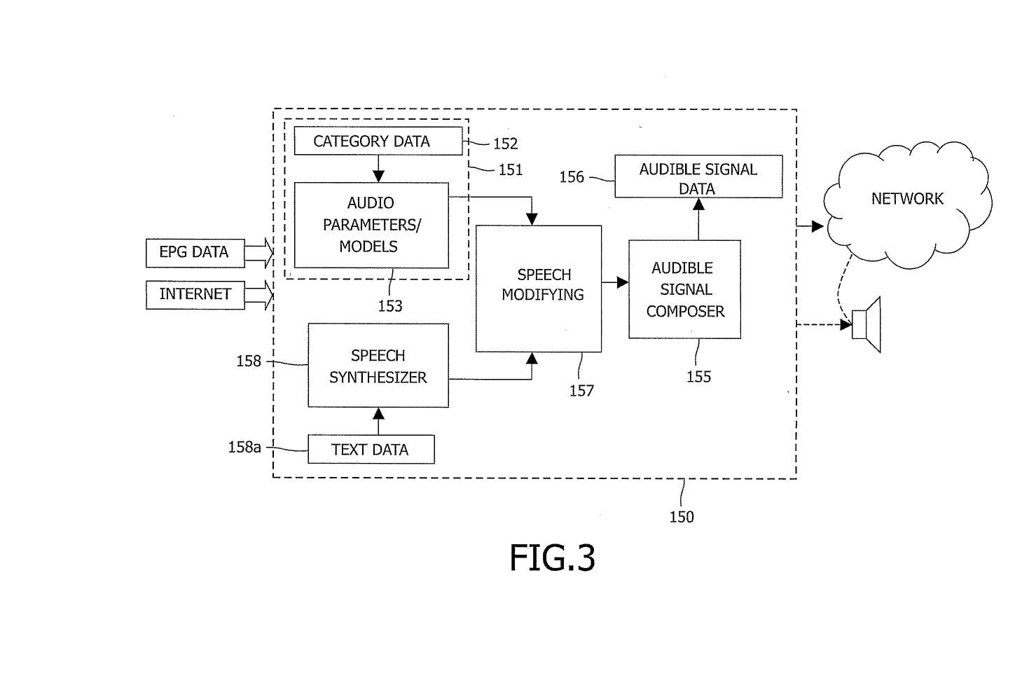

FIG. 3 is a functional block diagram of an embodiment of a device according to the present invention, wherein the audible signal is synthesized and modified by using the audio parameter associated with the category;

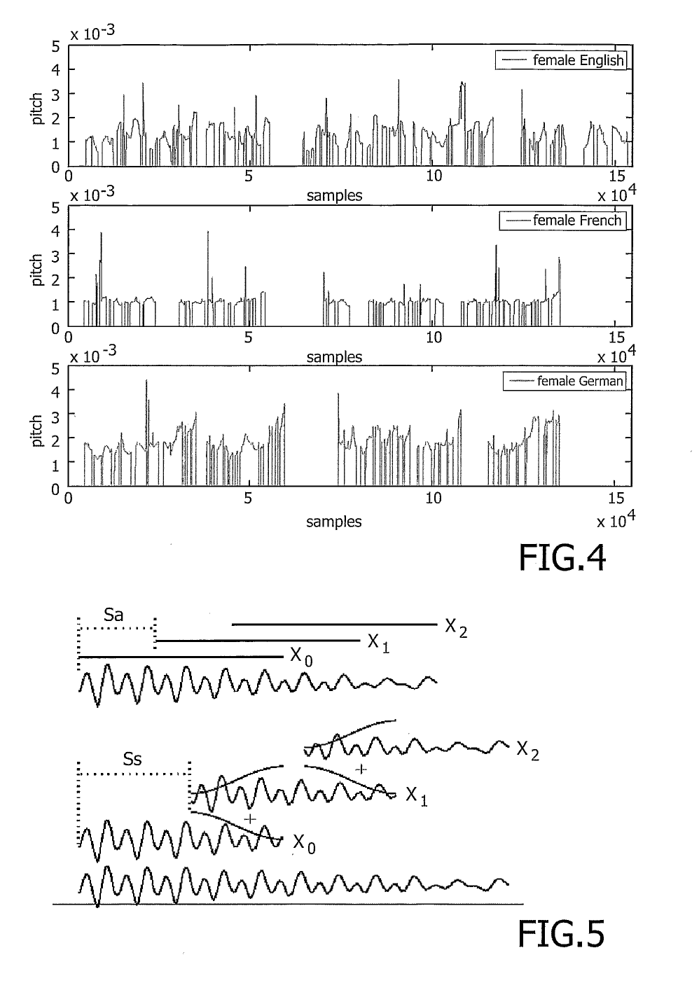

FIG. 4 shows an example of a deviation of (normalized) pitch for the female English voice, the female French voice, and the male German voice;

FIG. 5 is a diagram representing a time-scale modification of the audio sample to increase a time length of the audio sample, while preserving (most of) the pitch characteristics;

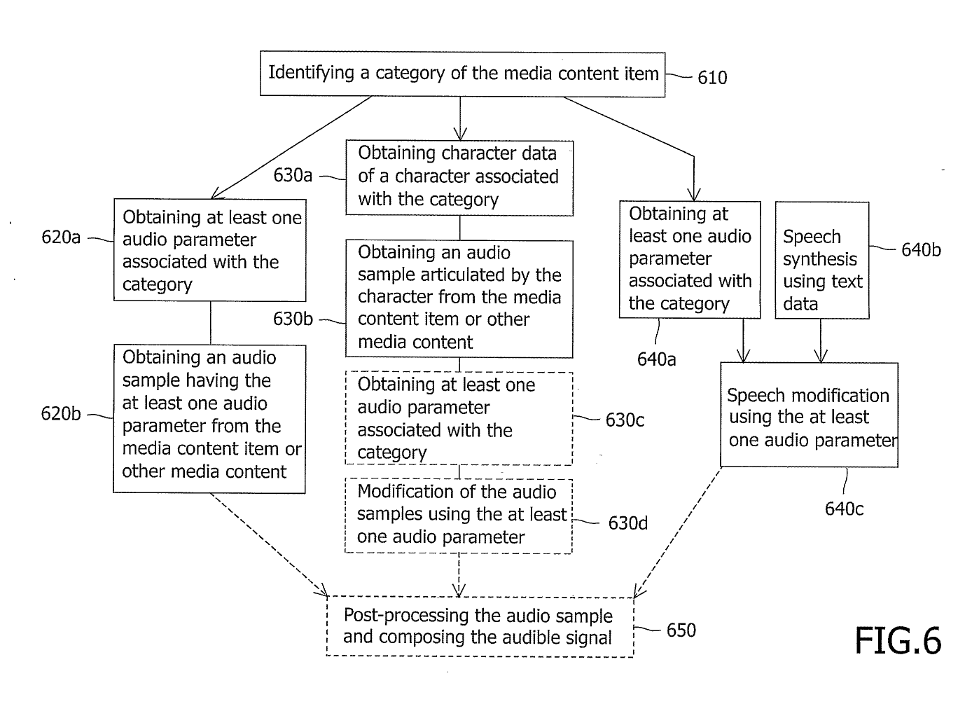

FIG. 6 shows embodiments of the method of the present invention. Throughout the Figures, identical reference numerals indicate the same or corresponding components.

FIG. 1 is a block diagram of an embodiment of the present invention. It shows an EPG source 111 of EPG (Electronic Program Guide) data and an Internet source 112 of information.

The EPG source 111 is, for example, a TV broadcaster (not shown) that transmits television signals including the EPG data. Alternatively, the EPG source is a computer server (not shown) communicating with other apparatuses through the Internet (e.g. using the Internet Protocol (IP)). For example, the TV broadcaster stores the EPG data for one or more TV channels at the computer server.

The Internet source 112 stores Internet information related to a category of a particular media content item. For example, the Internet source is a web-server (not shown) storing a web-page with a review article about the particular media content item, and the review article discusses a genre of this media content item.

The EPG source 111 and/or the Internet source 112 are configured to communicate with a data-processing device 150. The data-processing device receives the EPG data or the Internet information from the EPG source or the Internet source to identify a category of a media content item.

A media content item may be an audio content item, a video content item, a TV program, a menu item on a screen, a UI element such as a button associated with media content, a summary of a TV program, a rating value of the media content item by a media content recommender, etc.

The media content item may comprise at least one of, or any combination of, visual information, audio information, text, and the like. The expression “audio data”, or “audio content”, is used hereinafter as data pertaining to audio comprising audible tones, silence, speech, music, tranquility, external noise or the like. The expression “video data”, or “video content”, is used as data which are visible such as a motion picture, “still pictures”, video text, etc.

The data-processing device 150 is configured to enable a user to obtain an audible signal that is related to the category of the media content item. For example, the data-processing device is implemented in an audio player with a touch-screen for displaying a menu of music genres. The user may select a desired music genre, such as “classical”, “rock”, “jazz”, etc. from the menu. When the user presses on the rock menu item, the audio player reproduces an audible signal which sounds like typical rock music. In another example, the data-processing device is implemented in a TV set with a display for displaying a menu of TV program genres. The user may select a desired TV program genre, such as “movie”, “sport”, “news”, etc. from the menu. The selection may be done by pressing up/down buttons on a remote control unit for controlling the menu. When the user selects the news menu item, the TV set reproduces an audible signal which sounds like a TV news broadcast.

The data-processing device 150 may comprise memory means 151, for example, the known RAM (random access memory) memory module. The memory means may store a category table comprising one or more categories of media content. An example of the category table is shown in the Table.

| | TABLE | |
|---|---|---|
| | Audio parameter or parameters | |
| | voiced content out | speech rate |
| Category data | of the total, % | (words per minute) |
| Video: movie: action | 55-70 | 220-280 |
| Video: movie: science fiction | 45-60 | 190-210 |
| Video: TV news | 55-60 | 170-200 |
| Video: sport | 55-65 | 210-230 |
| Video: drama | 40-50 | 140-160 |

The data-processing device 150 may be configured to identify the category of the media content item, upon selection of the media content item, from the received EPG data or Internet information. The category of the media content item may be indicated by category data 152 stored in the memory means 151.

In certain cases, the category of the media content item is evident from the media content item itself, e.g. the category of the rock menu item described above is clearly “rock”, and there is no need to use the EPG data or Internet information.

As an example, the media content item is a TV program. The identification of a category of the TV program depends on a format of the EPG data received by the data-processing device 150. The EPG data typically store a TV channel, broadcast time, etc. and, possibly, an indication of the category of the TV program. For example, the EPG data is formatted in the PSIP (Program and System Information Protocol) standard. The PSIP is the ATSC standard (Advanced Television Systems Committee) for carriage of basic information required within the DTV (Digital TV) transport stream. The two basic goals of PSIP are to provide basic tuning information to the decoder so as to help parse and decode the various services within the stream, and information required to feed the receiver's Electronic Program Guide (EPG) display generator. The PSIP data are carried via a collection of hierarchically arranged tables. According to the standard, there is also a table called Directed Channel Change Table (DCCT) defined at base PID (0x1FFB). In this DCCT, the Genre Category (dcc_selection_type=0x07, 0x08, 0x17, 0x18) is used to determine the category of the TV program that is transmitted by the TV broadcaster.

Other techniques for identifying the category of the media content item may be used. For example, the data-processing device 150 detects in the EPG data that the category of the TV program is indicated as “tragedy”, and compares the category “tragedy” with the category table of the memory means 151. The category “tragedy” is not stored in the category table. However, the data-processing device 150 may use any known heuristic analysis to establish that the category “tragedy” extracted from the EPG data is related to the category “drama” stored in the memory means 151. For example, it is conceivable to compare audio/video patterns extracted from the media content item, having the category “tragedy”, by using the audiovisual content analysis described in the book “Pattern Classification”, R. O. Duda, P. E. Hart, D. G. Stork, Second Edition, Wiley Interscience, 2001. If the pattern extracted from the media content item, having the category “tragedy”, matches or correlates with a predetermined audio/video pattern (e.g. stored in the category table) for the category “drama”, the equivalency of the category “tragedy” to the category “drama” is established.

The memory means 151 of the device 150 stores at least one audio parameter 153 in the category table, in addition to the category data 152. A particular category in the category table corresponds to a respective at least one audio parameter.

For example, the audio parameter is a speech rate of audio content. It determines a speed of uttering words (phonemes) in the audible signal. For example, the speech rate has approximately the following values: very slow—80 words per minute, slow—120 words, medium (default)—180-200 words, fast—300 words, very fast—500 words (see Table on page 5).

In another example, the audio parameter is the pitch that designates the frequency at which a voice of the audible signal sounds. In the field of speech analysis, the expressions “pitch” and “fundamental frequency” are often used interchangeably. In technical terms, the fundamental frequency of a periodic (harmonic) audio signal is the inverse of a pitch period length; the pitch period is, in turn, the smallest repeating unit of an audio signal. Clearly, a child or a female voice (e.g. 175-256 Hz) speaks with a higher pitch than a male voice (e.g. 100-150 Hz). The average frequency of a male voice may be around 120 Hz, but it is around 210 Hz for a female voice . A possible value of pitch and its frequency in Hertz may be expressed as very low, low, medium, high, and very high (different for the male and female voices), similarly as the speech rate.

A pitch range allows setting a voice's variation in inflection. The pitch range may be used as the audio parameter. Words are spoken with a highly animated voice, if a high pitch range is chosen. A low pitch range may be used to make the audible signal sound rather flat. Therefore, the pitch range gives some liveliness (or vice versa) to the audible signal. The pitch range may be represented as a pitch value of the average male or female voice varying for 0-100 Hz around that average voice. A constant pitch (whatever the value) corresponds to a repetitive tone. Therefore, it is not only the pitch range, but also the degree of variation of the pitch in that range (e.g. measured by means of standard deviation) that determines the dynamics (“liveliness”) of a voice. For example, the news category may be associated with a pitch range for conveying a “serious” message, e.g. the medium or a slightly more monotonic voice (120 Hz of the male voice plus/minus 40 Hz).

In one embodiment of the present invention, the audio parameter has different values with respect to languages used in the audible signal. FIG. 4 shows, as an example of the audio parameter, an example of the calculation of a deviation of (normalized) pitch for the female English voice: 0.219, for the female French: −0.149, and for the male German: −0.229. In FIG. 4, pitch is measured in speech samples (scaled), which is reverse to the usual measurement in Hertz.

The pitch contours that are plotted in FIG. 4 concern the speech samples that were provided for the experiment. They are only examples and cannot be generalized as being representative of the entire language. FIG. 4 illustrates the natural difference between female and male pitch. The pitch values were obtained by using a pitch-estimation algorithm similar to that described in chapter 14 “A robust Algorithm for Pitch Tracking” of the book “Speech Coding and Synthesis”, W. B. Kleijn, K. K. Paliwal (Editors), 1995, Elsevier Science B.V., The Netherlands.

The places in FIG. 4 where pitch is non-zero correspond to “voiced speech” (vowels, sounds like “a”, “e”, . . . ), and the 0-valued parts correspond to “unvoiced speech” (vowels, sounds like “f”, “s”, “h”, . . . ) and silences. The memory means 151 may store language-dependent category tables.

The music genres (e.g. “music: jazz”) may have the audio parameters, such as an amount of vocal-bass (40-900), vocal-tenor (130-1300), vocal-alto (175-1760), vocal-soprano (220-2100) in the media content item.

The category table is just an example of the determination of one of more audio parameters corresponding to the category data. Other ways of determining the audio parameter from the category data are possible. For example, the data-processing device 150 transmits the category data 152 via the Internet to a (remote) third party service provider, and receives the parameter or parameters from the third party service provider.

Alternatively, the device 150 may comprise user input means (not shown) enabling the user to specify the audio parameter in relation to the category of the media content item. The user input, i.e. the audio parameter, may be further stored in the category table in the memory means 151. The user input means may be a keyboard, e.g. a well-known QWERTY computer keyboard, a pointing device, a TV remote control unit, etc. For example, the pointing devices are available in various forms such as a computer (wireless) mouse, a light pen, a touchpad, a joystick, a trackball, etc. The input is provided to the device 150 by an infrared signal transmitted from the TV remote control unit (not shown).

The data-processing device 150 may further comprise a media content analyzer 154 (further referred to as “content analyzer”) coupled to a (remote) source of media content 161 and/or 162, e.g. via a satellite, terrestrial, cable or other link. The media content source may be a broadcast television signal 161 transmitted by a TV broadcast station or a media content database 162 for storing various media content.

The media content may be stored in the database 162 on different data carriers such as audio or video tapes, optical storage discs, e.g., a CD-ROM disc (Compact Disc Read Only Memory) or a DVD disc (Digital Versatile Disc), floppy and hard disks, etc. in any format, e.g. MPEG (Moving Picture Experts Group), MIDI (Musical Instrument Digital Interface), Shockwave, QuickTime, WAV (Waveform Audio), etc. As an example, the media content database 162 comprises at least one of: a computer hard disk drive, a versatile flash memory card, e.g. a “Memory Stick” device, etc.

One or more audio parameters are supplied from the memory means 153 to the content analyzer 154. Using the audio parameter or parameters 153, the content analyzer 154 extracts, from the media content available to it from the media content source 161 or 162, one or more audio samples which possess the required audio parameter or parameters 153.

Audio parameters of the available media content (not necessarily coinciding with the audio parameters 153) may be determined as described in the article by Yao Wang, Zhu Liu, and Jin-Cheng Huang, “MultimediaContent Analysis Using both Audio and Video Clues”, IEEE Signal Processing Magazine, IEEE Inc., New York, N.Y., pp. 12-36, Vol. 17, No 6, November 2000. The available media content is segmented. The audio parameters, which characterize segments, of two levels are extracted: a short-term frame level and a long-term clip level. The frame level audio parameter may be an estimation of a short-time autocorrelation function and average magnitude difference function, a zero-crossing rate and spectral features (e.g. pitch is determined from the periodic structure in the magnitude of the Fourier transform coefficients of a frame). The clip-level audio parameter may be volume, pitch or frequency-based.

The content analyzer 154 compares the audio parameter of the available media content with the audio parameter 153 obtained from the memory means 151. If a match is found, the audio sample or samples with the required audio parameter or parameters 153 are obtained from the available media content.

In one embodiment of the present invention, the content analyzer 154 is further configured to recognize (articulated) words in the audio samples of the available media content, e.g. by the pattern-matching technique described in chapter 47 “speech recognition by machine” of the book “The Digital Signal Processing Handbook”, Vijay K. Madisetti, Douglas B. Williams, 1998 by CRC Press LLC. If the content analyzer identifies, in the audio sample, one or more target words desired for inclusion in an audible signal informing the user about the category of the media content item, the audio sample is included in the audible signal.

In principle, the determination of the audio parameter is not mandatory for the purpose of obtaining one or more audio samples having the audio parameter associated with the particular category. For example, such audio samples are retrievable from a database (not shown) storing pre-recorded audio samples. The audio samples may be retrieved from the database upon a request indicating a particular category of media content. Alternatively, the audio samples may be retrieved from the database upon a request indicating a particular audio parameter. In one embodiment, the retrieved audio sample may be stored locally (e.g. in a cash memory), i.e. in the memory means 151 of the data-processing device 150 so that, if necessary, the audio sample is obtained from the local memory means instead of retrieving the audio sample from the remote database again.

The content analyzer 154 may be coupled to an audible signal composer 155 (further referred to as “composer”) for composing an audible signal 156 having the audio parameter 153 in accordance with the category of the media content item.

If more than one audio sample is obtained by the media content analyzer 154, the composer 155 may be arranged to “glue” the audio samples together to compose the audible signal 156. For example, a pause is inserted between the audio samples that are separate words. If the audio samples include words, a language in which the words are articulated determines whether e.g. accentuation techniques, word pronunciation techniques and intonation phrasing techniques described in chapter 46.2 by Vijay K. Madisetti et al. are applied to modify the audio samples. For example, less word-processing is required in Spanish or Finnish.

If only one audio sample is included in the audible signal 156, the composer 155 of the data-processing device 150 may not be required to perform any processing technique (e.g. the accentuation technique) on the audio sample.

The device 150 may be configured to output the audible signal 156 to a speaker 170 for reproducing the audible signal to the user. Alternatively, the device 150 may be configured to transmit audio data (not shown) comprising the audible signal through a computer network 180, e.g. the Internet, to a recipient device (not shown) or the (remote) speaker 170 connected to the Internet. Generally speaking, it is not required that the audible signal 156 is reproduced to the user by the speaker 170 coupled to the data-processing device 150, but the device 150 may merely obtain the audible signal 156 and the device 150 itself may not be designed to reproduce the audible signal 156. For example, the data-processing device is a networked computer server (not shown) for providing services to client devices (not shown) by composing and delivering the audible signal 156 to the client devices.

FIG. 2 is a block diagram of an embodiment of the present invention. The device 150 has the memory means 151 for storing the category data 152 in a category table (not shown). Instead of the audio parameter 153 as shown in FIG. 1, the category table stores character data 153a. The character data is, for example, a name of an artist or of a famous actor that the user associates with a particular category of media content. The character data may also comprise an image or voice characteristics of the artist or actor. In another example, the character data comprises a name of a member of a family, and an image or voice characteristics of the member.

In one embodiment, the device 150 comprises user input means (not shown) enabling the user to input the name of the actor or artist and indicate the category of media content to be associated with the name. The user input may be further stored in the category table in the memory means 151.

The media content analyzer 154 obtains the character data 153a from the memory means 151 to obtain one or more audio samples with the speech of a particular character indicated in the character data 152.

For example, the content analyzer 154 analyzes TV programs obtained from the media content source 161 or 162 by detecting a video frame in which the character is depicted. The detection may be done by using the image from the character data 152. After a plurality of the video frames has been detected, the content analyzer may further determine the audio sample or samples with the character's voice related to the video frame. Therefore, one or more audio samples articulated by the character associated with the category of the media content item are obtained.

The content analyzer 154 may be configured to utilize any one of the multimedia content analysis methods described in the book “Video Content Analysis Using Multimodal Information”, Ying Li, C.-C. Jay Kuo, 2003, Kluwer Academic Publishers Group to isolate individual shots and video scenes with the character (a target speaker) from the media content available from the media content source 161 or 162. Using content analysis methods (e.g. pattern recognition techniques known from the book “Pattern Classification”, R. O. Duda, P. E. Hart, D. G. Stork, Second Edition, Wiley Interscience, 2001), a mathematical model may be constructed and trained to recognize a voice or a face of the artist. The voice or face of the artist may be obtained from the Internet or in another manner. The recognition of the character may be assisted by the category data.

The speech recognition and speaker verification (identification) methods known from chapter 48 of the book “The Digital Signal Processing Handbook”, Vijay K. Madisetti, Douglas B. Williams, 1998 by CRC Press LLC may be used by the content analyzer 154 to automatically recognize the face and speech of the character (a target speaker) in the media content, e.g. the media content item.

Optionally, the content analyzer 154 provides the audio sample or samples to an audio sample modifier 157 (further referred to as “modifier”) for obtaining modified audio samples. The audio sample is modified on the basis of the audio parameter or parameters 153 representing the category of the media content item.

The book “Speech Coding and Synthesis”, W. B. Kleijn, K. K. Paliwal (Editors), 1995, Elsevier Science B. V., The Netherlands, describes, among other things related to speech signals, techniques of time and pitch-scale modification of speech in chapter 15 “Time-Domain and Frequency-Domain Techniques for Prosodic Modification of Speech”. The time and speech are dependent on the audio parameter or parameters 153. For example, the time-scale modification of speech means speeding up the articulation rate of speech while maintaining all the characteristics of the speaker's voice (e.g. pitch). The pitch-scale modification of speech means changing the pitch (e.g. making the words sound higher or deeper) while maintaining the speed of speech. An example of the time-scale modification by overlap-add is shown in FIG. 5. Frames X0, X1, . . . are taken from an original speech (i.e. the audio sample to be modified) (top) at a rate Sa and repeated at a slower rate Ss(>Sa). The overlapping parts are weighted by two opposite flanks of a symmetrical window and added together. Hence, a longer version of the original speech is obtained, while its shape is preserved. The time-scale modification may be applied to the audio samples comprising complete words.

In an embodiment of the present invention, the modifier 157 is dispensed with because the audio samples are articulated by the character that the user associates with the category of the media content item, and the modification of the audio samples is not required. The content analyzer 154 is arranged to determine, e.g. as described by Yao Wang et al., one or more audio parameters from the audio samples articulated by the character, and store the audio parameter or parameters related to respective category data 152 in the category table in the memory means 151.

The audio sample or samples obtained by the content analyzer 154 or, optionally, the modified audio sample or samples obtained by the modifier 157 are provided to the composer 155 for generating the audible signal 156.

FIG. 3 shows an embodiment of the data-processing device 150 of the present invention. The device 150 has the memory means 151 for storing the category data 152 and the respective audio parameter or parameters 153.

The device 150 comprises a speech synthesizer 158 for synthesizing a speech signal in which text data 158a is articulated. For instance, the text data may be a summary of a TV program (the media content item). The text data may be a title of a menu item associated with the category of media content (e.g. the text data of the rock menu item is “rock”).

For example, the speech synthesizer 158 is configured to utilize the text-to-speech synthesis method described, in particular, in chapter 46.3 of the book “The Digital Signal Processing Handbook”, Vijay K. Madisetti, Douglas B. Williams, 1998 by CRC Press LLC (see FIG. 46.1).

The speech synthesizer 158 is coupled to the modifier 157 for modifying the speech signal on the basis of the audio parameter or parameters 153. For example, the modifier 157 modifies the speech signal on a level of short segments (e.g. 20 ms) as described in chapter 46.2 of the book by Vijay K. Madisetti et al. The modifier may also modify the speech signal on the level of complete words, e.g. by applying the time-scale modification shown in FIG. 5, or as described in chapter 15: “Time-Domain and Frequency-Domain Techniques for Prosodic Modification of Speech” of the book by W. B. Kleijn.

The speech synthesizer 158 may generate audio samples articulating the desired text data 158a. The audio samples modified by the modifier 157 are supplied to the composer 155 for forming the audible signal 156 with one or more phrases comprising the text data 158a. As a result, for example, the phrase “Congratulations, Reg', it's a . . . squid” is articulated in the audible signal by an actor from the movie “Men in Black” to inform the user about the category “action” of that movie if the user wants the audible signal to comprise that phrase for the media content item of the category “Video:movie:action”.

The data-processing device 150 may comprise a data processor configured to function as described above with reference to FIGS. 1 to 5. The data processor may be a well-known central processing unit (CPU) suitably arranged to implement the present invention and enable the operation of the device 150. The device 150 may additionally comprise a computer program memory unit (not shown), for example, a known RAM (random access memory) memory module. The data processor may be arranged to read from the memory unit at least one instruction to enable the functioning of the device 150.

The devices may be any of various consumer electronics devices such as a television set (TV set) with a cable, satellite or other link, a videocassette or HDD-recorder, a home cinema system, a CD player, a remote control device such as an I-Pronto remote control, a cell phone, etc.

FIG. 6 shows an embodiment of the method of the present invention.

In step 610, the category of the media content item is identified, e.g. from the EPG source 111 or the Internet source 112, so that the category data 152 is obtained.

In the first embodiment of the method, at least one audio parameter 153 associated with the category of the media content item is obtained in step 620a. One or more audio parameters 153 may be provided together with respective category data 152 by a manufacturer of the data-processing device 150. Alternatively, the memory means 151 may be arranged to automatically download, e.g. through the Internet, the audio parameter or parameters from another remote data-processing device (or a remote server) storing audio parameters and associated categories set by another user. In another example, the data-processing device comprises the user input means (not shown) to update the category table stored in the memory means 151.

In step 620b, the audio sample or samples having the at least one audio parameter are obtained from the media content item or other media content, e.g. using the media content analyzer 154 as described above with reference to FIG. 1.

In step 650, the audible signal is generated from one or more audio samples, e.g. using the audible signal composer 155.

In the second embodiment of the method, the character data 153a associated with the category data 152 is obtained in step 630a, e.g. using the category table stored in the memory means 151 shown in FIG. 2.

In step 630b, one or more audio samples articulated by the desired character are obtained from the media content item or other media content, e.g. using the media content analyzer 154 as described above with reference to FIG. 2.

Optionally, at least one audio parameter 153 associated with the category 152 is obtained in step 630c, and one or more audio samples obtained in step 630b are modified, using the at least one audio parameter in step 630d, e.g. using the modifier 157 shown in FIG. 2.

The at least one audio sample obtained in step 630b or, optionally, the at least one modified audio sample obtained in step 630d is used to compose the audible signal in step 650, e.g. using the media content composer 155.

In the third embodiment of the method, at least one audio parameter associated with the category is obtained in step 640a, e.g. using the memory means 151. In step 640b, the speech synthesizer 158 is used to synthesize the speech signal in which the text data 158a is articulated.

In step 640c, the speech signal is modified, using the at least one audio parameter obtained in step 640a. The audible signal composer 155 may be used to obtain the audible signal from the modified speech signal, in step 650.

Steps 620a to 620b may describe the operation of the data-processing device shown in FIG. 1, steps 630a to 630d may describe the data-processing device shown in FIG. 2, and steps 640a to 640c may describe the data-processing device shown in FIG. 3.

Variations and modifications of the described embodiments are possible within the scope of the inventive concept.

The processor may execute a software program to allow execution of the steps of the method of the present invention. The software may enable the apparatus of the present invention independently of where it is being run. To enable the apparatus, the processor may transmit the software program, for example, to the other (external) devices. The independent method claim and the computer program product claim may be used to protect the invention when the software is manufactured or exploited to run on the consumer electronics products. The external device may be connected to the processor using existing technologies, such as Blue-tooth, 802.11 [a-g], etc. The processor may interact with the external device in accordance with the UPnP (Universal Plug and Play) standard.

A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer. In the device claim enumerating several means, several of these means can be embodied by one and the same item of hardware.

Use of the verb ‘to comprise’ and its conjugations does not exclude the presence of elements or steps other than those defined in a claim. In the claims, any reference signs placed between parentheses shall not be construed as limiting the claim. All details may be replaced with other technically equivalent elements.

1. A method of informing a user about a category (152) of a media content item, the method comprising the steps of:
(610) identifying the category of the media content item, and
(650) enabling a user to obtain an audible signal (156) having an audio parameter (153) in accordance with the category of the media content item.

2. The method of claim 1, further comprising:
a step (620b) of obtaining at least one audio sample of media content having the audio parameter associated with the category,
a step (650) of composing the audible signal from the at least one audio sample.

3. The method of claim 2, wherein the at least one audio sample is articulated by a particular character (153a).

4. The method of claim 1, further comprising:
a step (630b) of obtaining at least one audio sample of media content articulated by a particular character (153a) associated with the category.

5. The method of claim 4, further comprising:
a step (630d) of modifying the at least one audio sample on the basis of the audio parameter so as to obtain the audible signal.

6. The method of claim 4, further comprising a step of determining the audio parameter by analyzing the at least one audio sample articulated by the particular character.

7. The method of claim 2, wherein the at least one audio sample is obtained from the media content item.

8. The method of claim 1, further comprising a step (640c) of synthesizing the audible signal, using the audio parameter.

9. The method of claim 1, wherein a particular text (158a) is articulated in the audible signal.

10. The method of claim 1, wherein the category is a class of video content or audio content in accordance with a genre classification.

11. The method of claim 1, wherein the media content item is associated with more than one category, and the audible signal is obtained in accordance with a dominant one of the categories of the media content item.

12. The method of claim 1, wherein the media content item is recommended to the user by recommender means, using the audible signal.

13. The method of claim 9, wherein the particular text is
a TV program summary obtained from EPG data, or
a category name of the media content item obtained from EPG data.

14. The method of claim 1, wherein said method enables the user to input the audio parameter in relation to the category of the media content item, using user input means.

15. A data-processing device for informing a user about a category (152) of a media content item, the device comprising a data processor (150) configured to
identify the category of the media content item, and
enable the user to obtain an audible signal (156) having an audio parameter (153) in accordance with the category of the media content item.

16. Audio data comprising an audible signal (156) informing a user about a category (152) of a media content item when said audible signal is presented to the user, the audible signal having an audio parameter (153) in accordance with the category of the media content item.

17. A computer program product enabling a programmable device when executing said computer program product to function as the device as claimed in claim 15.

18. A database comprising a plurality of the audio data as claimed in claim 16, wherein a respective one of audio data has the audio parameter associated with a respective category of media content.
